(19) United States
(12) Patent Application Publication
(10) Pub. No.: US 2023/0285918 A1
(43) Pub. Date: Sep. 14, 2023

(54) WALL ASSEMBLY FOR CATALYTIC BEDS OF SYNTHESIS REACTORS

(71) Applicant: CASALE SA, Lugano (CH)

(72) Inventor: Nicola Panzeri, Breganzona (CH)

(21) Appl. No.: 18/007,416

(22) PCT Filed: Aug. 9, 2021
(86) PCT No.: PCT/EP2021/072184

§ 371 Date: Jan. 30, 2023

(30) Foreign Application Priority Data
Aug. 13, 2020 (EP) 20190846.4

(51) Int. Cl. B01J 8/02

(52) U.S. Cl. CPC B01J 8/0214; B01J 2208/00548; B01J 2208/00805; B01J 2208/00884; B01J 2208/0092

(57) ABSTRACT

Gas-permeable assembly (10) for retaining a fine granular catalyst (1) comprising: a first wall (2) arranged to face the catalyst, a second wall spaced from the first wall (4) and arranged to be opposed to the catalyst, a catalyst-retaining core (3) interposed between said first wall and second wall.

### FIELD OF APPLICATION

The present invention concerns the field of reactors with catalytic beds including a catalyst in a granular form and traversed by a gaseous stream. In particular the present invention concerns the design of a gas-permeable wall assembly arranged to retain the solid catalyst.

### Prior Art

A number of chemical converters of industrial interest require a suitable distribution and collection of a gaseous stream of reactants or products to/from a catalytic bed wherein the catalyst is in a granular form. Examples of notable interest include the reactors for the synthesis of ammonia and methanol.

The catalytic bed usually has the shape of a cylinder annulus delimited by an outer wall and an inner wall. Said inner wall and outer wall are commonly referred to as inner collector and outer collector. One of said walls acts as a gas distributor and the other acts as a gas collector. The gaseous flow through the catalytic bed may be substantially radial or axial-radial.

Said collectors need to comply with several conflicting requirements. Their design is therefore a challenging task. First, the collectors are required to be gas-permeable to allow the passage of the gaseous stream of reactants and products. To this purpose the collector must have openings of a sufficient size and number to provide a required passage area. An insufficient passage area would increase the velocity of the gaseous flow, increase the pressure drop and affect the operation of the catalyst.

The collectors must also be able to retain the catalyst, which means the size of the gas-passage openings may be dictated by the size of the granules of catalyst. Particularly, a collector must be designed to prevent the migration of the catalyst outside the collector and reduce the risk of occlusion of the gas-passage openings caused by the catalyst itself. The occlusion of gas passages would reduce the available area with the disadvantages mentioned above and would cause uneven distribution of the input gas in the catalytic bed.

In addition to the above, the collectors must also perform a structural function particularly to resist the pressure of the catalyst. In many reactors of interest, e.g. industrial ammonia converters and methanol converters, the catalytic bed has a considerable size and height in the axial direction, thus the mechanical stress of the collectors is relevant. Particularly, the inner surface in a direct contact with the catalyst may receive a tangential stress and a radial stress of a significant entity.

There is a growing interest to the use of so-called fine catalysts, i.e. catalyst made of particles of small size. Typically, a catalyst made of particles having a nominal size of 1.5 mm or less is considered a fine catalyst. Some fine catalysts may have a nominal size as small as 1 mm or less. The size of the catalyst refers to a characteristic dimension of the granules, e.g. to the diameter of spherical particles. The size may follow a statistical distribution and the nominal size may refer to the average size.

A fine catalyst is advantageous for the conversion rate and therefore attractive for the economic profitability of the reactor. Particularly a fine catalyst increases the contact area with the gaseous stream. However, the containment of a fine catalyst is challenging. The collectors are more exposed to the risk of clogging of the openings and/or may not be able to retain the small particles of catalyst.

Simply reducing the size of the wall openings does not provide a solution to this problem. Small openings may introduce excessive pressure drops and deviate from the optimal gas flow distribution. The need to provide a sufficient gas passage area may require a large number of such small openings making the perforated walls unpractical to manufacture. Moreover, a large number of openings may weaken the resistance to mechanical stress.

In light of these considerations, it is clear that the design of a catalytic collector is a challenging task. An ideal assembly needs to retain fine catalytic particles, avoid clogging of the openings, maintain an optimal gaseous flow distribution while retaining the mechanical properties required to satisfy the integrity of the collector.

### SUMMARY OF THE INVENTION

The object of the present invention is to overcome the drawbacks of the prior art as above described. Particularly, an object of the invention is to provide a collector able to retain a fine granular catalyst and at the same time to provide the structural support to the granular mass of catalyst.

The above aim is reached with a gas permeable assembly according to the claims.

The assembly is adapted for retaining a fine granular catalyst and comprises a first wall arranged to face the catalyst; a second wall spaced from the first wall and arranged to be opposed to the catalyst; a catalyst-retaining core interposed between said first wall and second wall.

The first wall and the second wall are made gas-permeable by suitable openings, for example holes or slots. The catalyst-retaining core is also gas-permeable by virtue of openings or suitable void patterns in its structure.

In the assembly of the invention, the structural function of supporting the catalyst is performed predominantly by the first wall and the second wall; the function of retaining the catalyst is performed mainly by the core. The term of catalyst-retaining core denotes that the core is designed to retain the fine granular catalyst and the function of retaining the catalyst is performed predominantly or exclusively by the core, whilst the first wall and the second wall provide the structural support of the assembly.

The first wall and the second wall can be designed with a conventional pattern of openings, arranged to provide a desired cross-sectional passage and to minimize the pressure drop, even with a fine catalyst. For example the openings may be larger than a size of the granules of catalyst. The catalyst-retaining core, on the other hand, can be designed to suitably contain the fine catalyst without having to resist the pressure of the same. The core has gas passages smaller than a size of the granules of catalyst, to perform its function of a catalyst-retaining member.

The size of the catalyst may be a maximum width of the granules or may be defined operatively by reference to a sieving process.

For example a size of a catalyst can be defined on the basis of the maximum square free flowing area of a sieve which retains the catalyst. More particularly, it can be assumed that the size of the catalyst is equal to the square root of said area. The determination of the size by sieving the catalyst can be performed, preferably, according to the standard test method disclosed in ASTM D4513-11 and particularly according to the standard specification of ATSM E11-17.

Another advantage of the present invention is that the core is in a direct contact with the catalyst at small areas only. A direct contact with the catalyst on the whole surface would cause wear, e.g. due to displacement of the catalyst particles in operation. In the assembly of the invention the core is actually protected by the first wall from such relative displacement and relevant friction. Therefore, the core can be chosen or designed primarily for the retention of catalyst without having to fulfil stringent structural requirements.

The catalyst-retaining core may include at least one of the following: a porous medium; a net; an overlapping of nets; a fibrous medium; a microfibrous medium; a fabric; a metallic fibre felt; a perforated plate. In the various embodiments, the core has a suitable characteristic dimension compatible with the catalyst size.

The assembly of the invention achieves the goal of providing a safe and reliable containment for a fine catalyst and at the same time a good performance in terms of stress resistance. It can be understood that the invention provides a composite wall structure wherein different components cooperate to satisfy the mechanical requirements and the process requirements.

The invention includes as well a catalytic reactor comprising at least one catalytic bed and a gas-permeable assembly according to any of the embodiments herein described. The reactor is preferably an ammonia converter or a methanol converter. Particularly the invention concerns a reactor including a catalytic bed of cylindrical annular shape delimited by an inner collector and an outer collector, wherein at least one of the inner and outer collector includes a gas-permeable assembly according to the present invention. The catalytic bed and the collectors may be part of a catalytic cartridge inserted in a pressure vessel.

Preferably the catalytic bed of the reactor is made of a fine catalyst having a nominal size of the catalyst granules not greater than 1.5 mm, preferably not greater than 1.2 mm, more preferably not greater than 1.0 mm.

### DESCRIPTION OF THE INVENTION

The core may partially or completely fill the gap between the first wall and second wall. In an embodiment, the gap is completely filled by the core. In an embodiment, the core is sandwiched between the first wall and the second wall, being in contact with both. In a preferred embodiment, the assembly has a three-layer structure constituted by the above mentioned first wall, second wall and central core forming a sandwich wall.

By filling the gap between the first wall and the second wall, the core may contribute to the transfer of mechanical stress from one wall to the other, so that the two walls cooperate structurally. Accordingly, the mechanical forces are withstood by the first wall and second wall; the core however contributes to the distribution of the forces from one to another.

To make the overall assembly permeable to gas, the first wall, the second wall and the catalyst-retaining core has gas passages. The gas passages of the walls may be holes or apertures made in the walls. The gas passages of the core may be in the form of void patterns particularly when the core is a porous medium, a fibrous or microfibrous medium, a fabric or a metallic fibre.

The catalyst-retaining core has gas passages smaller than gas passages of said first wall and second wall. Having smaller gas passages, the core is able to retain a fine catalyst which would not be contained by the first wall and second wall.

The gas passages of the core may be denoted by a characteristic size. Said characteristic size may be a diameter of circular or openings or a maximum width of openings of a different shape, e.g. openings with an elongate shape or slit-shaped.

The core may have a suitable void pattern to allow the passage of the gaseous stream. Said void pattern may be represented e.g. by the passages in a porous medium, the mesh opening of a net or by the perforation of a plate used as the core element. The average area of passages in the pattern of the core may be smaller than the passage area of the openings of the walls. For example, said passage area may be defined in a plane perpendicular to the radial direction of a cylindrical-annular bed.

The catalyst-retaining core may include a single net or multiple nets that overlap between each other. The use of two or more nets for the core element is particularly cost-effective.

In embodiments using overlapping of nets, an interesting feature is that the mesh opening is not required to be smaller than the minimum size of the catalyst, thanks to the overlapping of the nets resulting in passages actually smaller than the mesh openings. Also in this case of overlapping nets, a characteristic size of the openings can be defined as the maximum width of the openings resulting from the overlapping.

In embodiments where the catalyst-retaining core includes a porous medium, a preferred porous medium is a metal sintered plate.

In embodiments where the catalyst-retaining core includes a woven net, the net may be similar to nets used in demister pads.

In embodiments where the catalyst-retaining core includes a fibrous medium, said fibrous medium may be a non-woven fibrous medium or non-woven micro-fibrous medium.

In embodiments where the catalyst-retaining core includes a fabric, this may be for example a ceramic fabric or a fabric made out of a sintered metal.

In some embodiments, the core as such may have a sandwiched structure including reinforcing perforated plates and a porous element like for example a net or multiple nets. For example, the core may have a reinforced mesh structure including a mesh element between reinforcing perforated plates. The reinforcing perforated plates are preferably of a metal.

In embodiments wherein the core is a perforated plate, the holes of the plate should be smaller than a characteristic dimension of catalyst particles. For example said characteristic dimension may be the diameter of spherical particles.

In a preferred embodiment the catalyst-retaining core is arranged so that part of the pressure exerted by the catalyst on the first wall is transferred by the core to the second wall. This requires the core to be sufficiently stiff to transfer said pressure to the second wall.

In a preferred embodiment the first wall facing the catalyst (inner wall) is structurally connected to the second wall (outer wall). Interconnection between the two walls can be achieved by welding the two walls together with connectors. The said connectors can be metallic pieces, preferably regularly spaced.

Said connectors may have different shapes wherein the most preferred are rectangular or cylindrical. The number of interconnections and the distance between them can be definite by mechanical strength calculations. Overall, the interconnection between the two walls assures a higher strength of the assembly, and allow a reduction of the thickness of the wall that faces the catalyst. In this way, the thickness of said wall can be optimised following process requirements.

Depending on the catalytic bed configuration, the gaseous flow that enters or leaves the assembly can either follow a substantially pure radial direction or an axial-radial direction. The radial flow may be inward, i.e. directed towards the axis of the reactor or outward, i.e. directed away from said axis.

The gas passage openings of the first and second wall are usually slits or holes having a suitable dimension and direction. In a preferred embodiment the gas passage openings have an elongated shape. The term of elongate shape denotes that the slit extends predominantly in a given direction. The slit of a wall may extend in the same or different directions.

The openings of the first wall and of the second wall may be arranged according to the same pattern or different patterns. In an embodiment, elongated slits of the first wall and of the second wall may be oriented according to the same direction or different directions. For example, in an embodiment the first wall has elongated slits oriented in a first direction and the second wall has slits oriented in a second direction different than the first direction. For example, the slits of the first wall and second wall may be arranged perpendicular to each other. A combination of multiple directions is also possible.

Said slits can either be manufactured through conventional fabrications processes such as water, laser cutting or electro-erosion. Alternative, when the gas openings are perforated holes, a mechanical punching method may be used. Punching method can also be used for other types of opening when allowed by the manufacturing technology. The mechanical punching method may be preferred for its low cost compared e.g. to a laser cutting.

The gas-permeable assembly of the present invention is most preferably cylindrical.

An interesting application of the invention concerns a reactor including a cylindrical-annular catalytic bed delimited by at least one collector having the assembly of the invention. The term collector denotes a gas-permeable wall arranged to distribute a gas entering the catalytic bed or to collect a gas effluent from the catalytic bed.

Said at least one collector may include an outer collector and an inner collector. One or both of the outer collector and inner collector can include with the assembly of the invention. In some embodiments, a reactor may include a catalytic bed with only one collector, for example only an outer collector. A particularly interesting application of the invention concerns reactors for the ammonia and methanol synthesis.

Still another aspect of the invention is a reactor for the synthesis of chemical compounds, preferably ammonia or methanol, comprising at least one catalytic bed of cylindrical annular shape delimited by at least one collector, wherein the catalytic bed contains a granular catalyst, wherein at least one collector of the catalytic bed includes a gas-permeable assembly, wherein:

said assembly includes a first wall facing the catalyst, a second wall spaced from the first wall, a core element between the first wall and the second wall,

the first wall and the second wall have gas-passage openings larger than a granule size of the granular catalyst, whilst the core has gas passages smaller than said granule size of the catalyst, so that the catalyst is retained in place by the core of the assembly.

Preferably, in the above reactor, the first wall and the second wall perform a structural load-bearing function of the assembly. Preferably the core is any of: a porous medium; a net; an overlapping of nets; a fibrous medium; a microfibrous medium; a fabric; a metallic fibre felt; a perforated plate

### DESCRIPTION OF THE FIGURES

FIG. 1 is a schematic drawing of a gas permeable assembly according to a preferred embodiment.

FIG. 2 is a perspective view of a gas permeable assembly according to an embodiment.

FIG. 3 is a perspective view of another embodiment of the assembly.

FIG. 4 is a perspective view of another embodiment of the assembly.

FIG. 5 is a section of another embodiment of the assembly.

FIG. 6 is a schematic section of a catalytic bed.

### DETAILED DESCRIPTION OF PREFERRED EMBODIMENTS

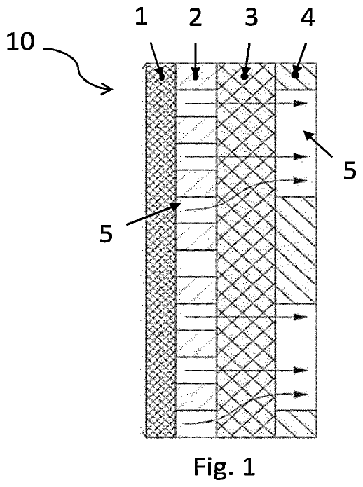

FIG. 1 illustrates schematically a cross section of a wall assembly 10 in contact with a catalyst layer 1. For example FIG. 1 illustrates an outer wall assembly of a radial-outward flow catalytic bed.

The assembly 10 comprises a gas-permeable inner wall 2 facing the catalyst layer 1 and a gas-permeable outer wall 4 opposed to the catalyst. The assembly 10 further comprises a catalyst-retaining core 3 interposed between said inner wall 2 and outer wall 4.

The catalyst-retaining core 3, enclosed between the two walls 2 and 4, retains the particles of catalyst and may be designed to properly retain a fine catalyst. Conversely, the gas permeable walls 2 and 4 act as structural support to the core 3.

Openings 5 are located over the surface of said walls 2 and 4 and allow the passages of the gaseous flow through the catalytic bed. The design of said openings 5 may be selected to allow an optimum pressure drop and an optimal gaseous flow distribution across the catalytic bed.

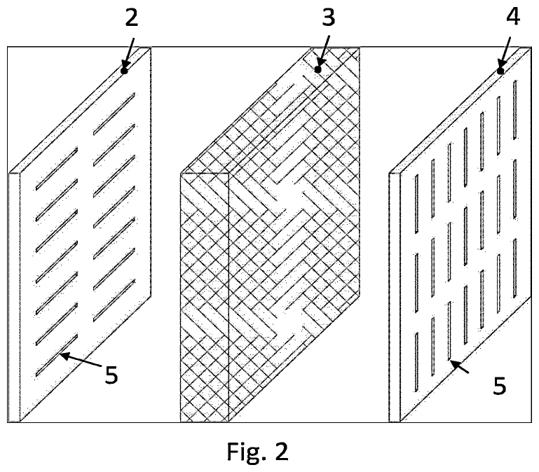

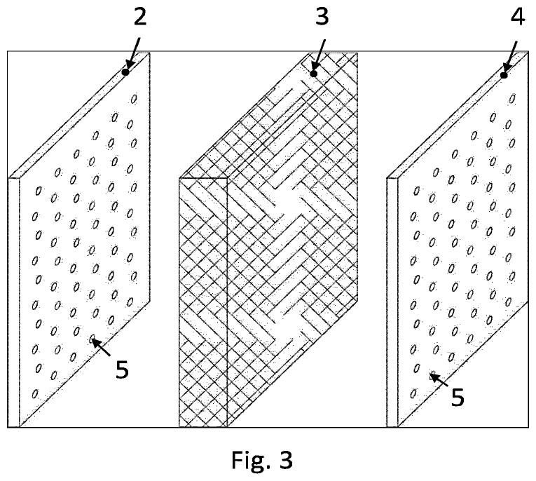

The openings 5 can be elongated slits as in FIG. 2 or holes as in FIG. 3. The holes can be manufactured through a process cheaper than the conventional methods i.e. a punching method can be used instead of electro-erosion or water-jet cut.

FIG. 2 illustrates an embodiment wherein the inner wall 2 and outer wall 4 have opening 5 with a different pattern. Particularly FIG. 2 illustrates an embodiment wherein the openings are in the form of elongated slits arranged in a first direction on the inner wall 2 and in a second direction on the outer wall 4.

The walls 2 and 4 may be interconnected through welding elements not shown in the figures. The number and dimension of the said continuous elements are defined by structural integrity requirements.

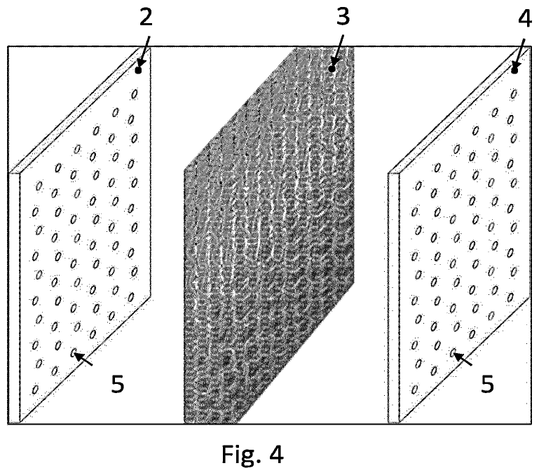

FIG. 4 illustrates an example of a core 3 made of a demister pad-type mesh.

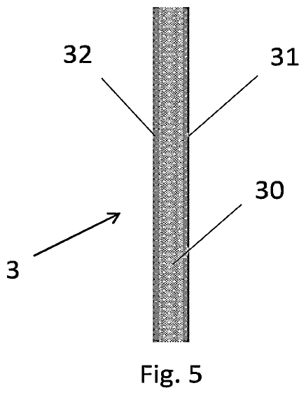

FIG. 5 illustrates an example wherein the core 3 has a reinforced mesh structure including a mesh element 30 sandwiched between perforated reinforcing plates 31, 32.

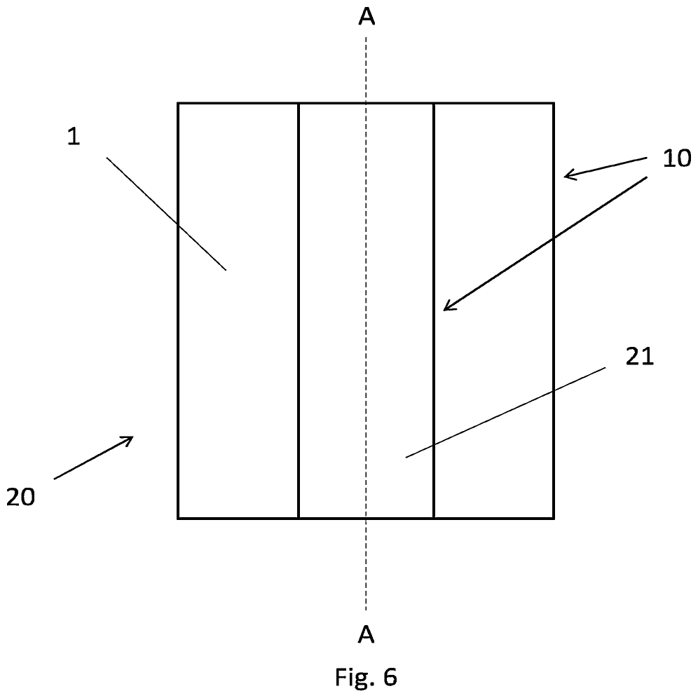

FIG. 6 is a sketch of an annular-cylindrical catalytic bed 20 showing the position of the inner collector and outer collector made with the assembly 10.

The bed 20 has an axis A-A and a central cavity 21. In some embodiments, an inter-bed heat exchanger may be mounted in the cavity 21.

1-18. (canceled)

19. A gas-permeable wall assembly for use in a catalytic reactor for retaining a granular catalyst, the gas-permeable assembly comprising:
a first wall arranged to face the granular catalyst;
a second wall spaced from the first wall and arranged to be opposed to the granular catalyst; and
a catalyst-retaining core interposed between said first wall and said second wall;
wherein said catalyst-retaining core has gas passages smaller than gas passage openings of said first wall and said second wall;
wherein the catalyst-retaining core includes at least one of the following: a porous medium; a fibrous medium; a micro-fibrous medium; a fabric; or a metallic fiber felt.

20. The gas-permeable assembly according to claim 19, wherein the catalyst-retaining core partially or completely fills the gap between the first wall and the second wall.

21. The gas-permeable assembly according to claim 19, wherein the catalyst-retaining core includes a porous medium and said porous medium is a metal sintered plate.

22. The gas-permeable assembly according to claim 19, wherein the catalyst-retaining core includes a fibrous medium and said fibrous medium is non-woven.

23. The gas-permeable assembly according to claim 19, wherein the catalyst-retaining core includes a fabric and said fabric includes a ceramic or a sintered metal.

24. The gas-permeable assembly according to claim 19, wherein said catalyst-retaining core includes a mesh element sandwiched between reinforcing perforated plates.

25. The gas-permeable assembly according to claim 19, wherein the catalyst-retaining core is able to retain a fine catalyst not contained by the first wall and the second wall, said fine catalyst having a nominal size of catalyst granules not greater than 1.5 mm.

26. The gas-permeable assembly according to claim 19, wherein the catalyst-retaining core is arranged so that part of a pressure exerted by the granular catalyst on the first wall is transferred by the catalyst-retaining core to the second wall, wherein said catalyst-retaining core has a stiffness suitable to transfer part of said pressure exerted by the granular catalyst from the first wall to the second wall.

27. The gas-permeable assembly according to claim 19, wherein the first wall is structurally connected to the second wall.

28. The gas-permeable assembly according to claim 27, wherein the first wall is connected to the second wall through elements regularly spaced.

29. The gas-permeable assembly according to claim 19, wherein the first wall has openings arranged according to a first pattern and the second wall has openings arranged according to a second pattern different from said first pattern.

30. The gas-permeable assembly according to claim 29, wherein the openings of the first wall and the openings of the second wall have an elongated shape or a shape of circular holes.

31. The gas-permeable assembly according to claim 19, wherein the first wall, the second wall, and the catalyst-retaining core are cylindrical.

32. A reactor for the synthesis of chemical compounds, the reactor comprising:
at least one catalytic bed of cylindrical annular shape delimited by at least one collector including the gas-permeable assembly according to claim 19.

33. A reactor for the synthesis of chemical compounds, the reactor, comprising:
at least one catalytic bed of cylindrical annular shape containing a granular catalyst, wherein said catalytic bed includes at least one collector having a gas-permeable assembly,
wherein said gas-permeable assembly includes a first wall facing the granular catalyst, a second wall spaced from the first wall, and a core element between the first wall and the second wall;
wherein the first wall and the second wall have gas-passage openings larger than a granule size of the granular catalyst, whilst the core element has gas passages smaller than said granule size of the catalyst, so that the granular catalyst is retained in place by the core element.

34. The reactor according to claim 33, wherein the first wall and the second wall perform a structural load-bearing function.

35. The reactor according to claim 33, wherein the core element includes at least one of: a porous medium; a net; an overlapping of nets; a fibrous medium; a micro-fibrous medium; a fabric; a metallic fiber felt; or a perforated plate.
